(19) United States
(12) Patent Application Publication
(10) Pub. No.: US 2022/0100548 A1
(43) Pub. Date: Mar. 31, 2022

(54) NETWORK PERFORMANCE ASSURANCE SYSTEM AND NETWORK PERFORMANCE ASSURANCE METHOD

(71) Applicant: Nippon Telegraph and Telephone Corporation, Tokyo (JP)

(72) Inventor: Yoshito ITO, Musashino-shi, Tokyo (JP)

(21) Appl. No.: 17/424,101

(22) PCT Filed: Jan. 17, 2020
(86) PCT No.: PCT/JP2020/001414

§ 371 Date: Jul. 19, 2021

(30) Foreign Application Priority Data
Jan. 30, 2019 (JP) 2019-014760

(51) Int. Cl. G06F 9/455; G06F 9/50; H04L 41/14; H04L 43/0888

(52) U.S. Cl. CPC G06F 9/45558; G06F 9/5038; G06F 2009/45562; H04L 43/0888; H04L 41/145

(57) ABSTRACT

[Problem] A resource allocation amount such as the number of VMs/containers is appropriately controlled using autoscaling.

[Solution] A network performance assurance system 10 performs autoscaling to increase or reduce the number of VMs/containers V1 to V4 (V1 to V4) generated in a server and resources of V1 to V4. A data collection unit 11 a collects measurement data including a resource usage amount related to an operation of resources according to a resource allocation amount (amount of allocation) of V1 to V4 and a performance value of a communication service related to V1 to V4. A learning unit 12b sets, from the performance values included in the collected measurement data, a performance value having a high correlation with the amount of allocation as a model performance value. An optimal estimation calculation unit 12c obtains a performance estimation value according to a change in the amount of allocation using regression analysis on the model performance value and the performance value related to the resources corresponding to the model performance value, and calculates an amount of allocation when the estimation value satisfies a target value of the performance value and the amount of allocation is minimized. A resource control unit 11b increases or reduces the resources of V1 to V4 using the autoscaling according to the calculated amount of allocation.

### TECHNICAL FIELD

The present invention relates to a network performance assurance system and a network performance assurance method for autoscaling of the number of virtual machines (VMs) and containers, which are generated in a network-connected server, and resources such as a central processing unit (CPU), a memory, and the like.

### BACKGROUND ART

A network performance assurance system (also referred to as a system) is configured to use either or both of one or more VMs and containers in a physical server connected to a network. Either or both of VMs and containers will be represented as VMs/containers. VNF network functions virtualization is configured with such VMs/containers.

In addition, a quality of a communication service such as latency or throughput in a network using a plurality of VMs/containers will be referred to as “performance” or “performance value”. In other words, good performance indicates a good communication service quality, and poor performance indicates a poor communication service quality.

Autoscaling is a function of automatically increasing or reducing the number of VMs/containers in response to a server load. Autoscaling enables the number of VMs/containers to automatically increase when access is concentrated on a server of a system and the number of VMs/containers to be reduced when there is little access to make the system operated with the optimal number of VMs/containers as much as possible.

Autoscaling includes scale-out in which the number of VMs/containers is increased to enhance server performance, and conversely, scale-in in which the number of VMs/containers is reduced to make the server performance appropriate. Autoscaling further includes scale-up in which resources such as a CPU, memory, or the like are added to VMs/containers to enhance server performance, and conversely, scale-down in which resources of VMs/containers are deleted to make server performance appropriate. Note that scale-out or scale-in will be represented by scale-out/in, and scale-up or scale-down will be represented by scale-up/down.

Autoscaling of the system described above is exemplified as the technology of Non Patent Literatures 1 and 2. Non Patent Literature 1 discloses a broad concept of performance control taking a service level objective (SLO) value or performance target value into account. On the other hand, in the specification and function introduced in Non Patent Literature 2, existing autoscaling that is a performance control technique in the virtualization technology is designed to determine a scaling opportunity using a prescribed threshold value of a resource use rate for each VM/container. In such autoscaling, a resource allocation amount to the VM/container is changed by adding/removing resources such as a CPU and a memory in scale-up/down or scale-out/in.

### CITATION LIST

### Non Patent Literature

Non Patent Literature 1: M. G. Jaatun, et al., “SLA-Driven Adaptive Resource Management for Web Applications on a Heterogeneous Compute Cloud”, [online], 2009, [retrieved on Jan. 16, 2019], Internet <URL: http://www.cs.ait.ac.th/˜mdailey/papers/Iqbal-RTSLA.pdf>

Non Patent Literature 2: Fujitsu Cloud Technologies Limited, “Autoscaling of NIFCLOUD”, [online], 2017 to 2019, [retrieved on Jan. 16, 2019], Internet <URL: https://cloud.nifty.com/service/autoscale.htm>

### SUMMARY OF THE INVENTION

### Technical Problem

However, in the autoscaling technology of Patent Literature 2, the threshold value of the resource use rate, selection of a VM/container as a resource control target, and an amount of control such as an increase or reduction in the number of VMs/containers need to be appropriately stipulated by a person beforehand. There are problems that it is not easy for a person to set stipulation due to required time and efforts and the number of VMs/containers and a resource allocation amount cannot be appropriately controlled even when autoscaling control is performed after the stipulation.

In addition, in a VNF constituted by multiple VMs/containers, performance values of latency, throughput, and the like are complicatedly dependent on the number of virtual CPUs (vCPUs) and a capacity of memory of each VM/container and a resource allocation amount such as the number of VMs/containers, and a resource portion that becomes a bottleneck is present as follows.

For example, it is assumed that there are a plurality of VMs/containers V1, V2, . . . , Vk, . . . , and Vn in a VNF as illustrated in FIG. 9. In this case, if a performance value p of the VNF is dependent on resource allocation amounts r_{V1}, r_{V2}, . . . , r_{Vk}, . . . , r_{Vn} of the VMs/containers V1, V2, Vk, . . . , and Vn, respectively, the performance value p is expressed by the following function equation (1).

p=f(r_{V1}, r_{V2}, . . . , r_{Vk}, . . . , r_{Vn}) (1)

In such a case in which the performance value p is a function of the resource allocation amounts of VMs/containers V1, V2, Vk, . . . , and Vn, the performance value p of the overall VNF cannot be improved even if the resource allocation amount r_{Vk} of the only one VM/container Vk is increased (e.g., increased to three), as illustrated in FIG. 10. The reasons for this are as follows.

As in this example, even if only the resource allocation amount r_{Vk} of the one VM/container Vk is increased to three, the number of other VMs/containers V1, V2, . . . , and Vn is only one, thus the performance values p of these VMs/containers V1, V2, . . . , and Vn become insufficient, resulting in a bottleneck, and thus performance of the whole VNFs is not improved. In this case, it is only required to increase the number of the other VMs/containers V1, V2, . . . , and Vn, but it is not easy to determine the number of resources to increase because it is manual job and time and efforts are required.

Even if autoscaling to increase only the resource allocation amount r_{Vk} of the VM/container Vk is performed as described above, it is not possible to set the performance value of the VNF to the SLO (performance target value). In other words, even if autoscaling is performed, a resource allocation amount such as the number of VMs/containers cannot be appropriately controlled.

The present invention takes the above circumstances into consideration and aims to provide a network performance assurance system and a network performance assurance method that can appropriately control a resource allocation amount such as the number of VMs/containers using autoscaling.

### Means for Solving the Problem

As a means for solving the above-described problems, the invention according to first aspect is a network performance assurance system configured to perform autoscaling to increase or reduce the number of VMs/containers, which are either or both of virtual machines (VMs) and containers generated on a network-connected server and resources typified by a central processing unit (CPU) and a memory of each of the VMs/containers according to a resource allocation amount, the network performance assurance system including a first server having a plurality of types of the VMs/containers, a collection unit configured to collect measurement data including a resource usage amount obtained by measuring an operation of resources according to a resource allocation amount of the VMs/containers and a performance value of a communication service related to the VMs/containers, and a control unit configured to perform autoscaling to increase or reduce resources of the VMs/containers according to the resource allocation amount, and a second server having a learning unit configured to obtain, from the performance value included in the measurement data collected by the collection unit, a performance value having a high correlation with the resource allocation amount as a model performance value, and a calculation unit configured to obtain an estimation value of a performance according to a change in the resource allocation amount using regression analysis of the model performance value and a performance value related to the operation of resources corresponding to the model performance value and calculate a resource allocation amount when the estimation value satisfies a target value of the performance value and the resource allocation amount is minimized, in which the control unit increases or reduces resources of the VMs/containers by executing autoscaling according to the resource allocation amount that is calculated.

The invention according to seventh aspect is a network performance assurance method that is an autoscale-type performance assurance method of a system that performs autoscaling to increase or reduce the number of VMs/containers, which are either or both of VMs and containers generated on a network-connected server and resources typified by a CPU and a memory of each of the VMs/containers according to a resource allocation amount, in which the system includes a first server in which a plurality of types of the VMs/containers are generated, and a second server connected to the first server, the method including, by the first server, collecting measurement data including a resource usage amount obtained by measuring an operation of resources according to a resource allocation amount of the VMs/containers and a performance value of a communication service related to the VMs/containers, by the first server, performing autoscaling to increase or reduce resources of the VMs/containers according to the resource allocation amount, by the second server, obtaining, from the performance value included in the measurement data collected, a performance value having a high correlation with the resource allocation amount as a model performance value, by the second server, obtaining an estimation value of a performance according to a change in the resource allocation amount using regression analysis of the model performance value and a performance value related to the operation of resources corresponding to the model performance value and calculating a resource allocation amount when the estimation value satisfies a target value of the performance value and the resource allocation amount is minimized, and by the first server, increasing or reducing resources of the VMs/containers by executing autoscaling according to the resource allocation amount that is calculated.

According to the configuration of first aspect and the method of seventh aspect, the execution of the autoscaling in a small amount of allocated resources enables resource allocation to be performed such that wasted resources are reduced in the VMs/containers. As a result, the resource allocation amount such as the number of VMs/containers can be appropriately controlled with the autoscaling.

The invention according to second aspect is the network performance assurance system according to first aspect, in which the learning unit eliminates, from the measurement data collected by the collection unit, measurement data having a correlation between the measurement data and the resource allocation amount of the VMs/containers being greater than a predetermined first threshold value.

According to this configuration, the following effects are obtained. When the number of resources of the VMs/containers are changed according to the resource allocation amount, the measurement data that changes due to the aforementioned change (corresponding to a resource usage amount) is inappropriate for obtaining a model performance value. This inappropriate measurement data tends to increase when there is a high correlation with the measurement data of resources dependent on the resource allocation amount. Therefore, if the inappropriate measurement data is eliminated in advance as in the present invention, accuracy with which the model performance value can be estimated can be increased.

The invention according to third aspect is the network performance assurance system according to second aspect, in which the learning unit uses, from measurement data remaining after the elimination, measurement data having a correlation with the performance value of the communication service related to the VMs/containers being greater than a predetermined second threshold value to obtain the model performance value.

According to the configuration, the following effects are obtained. When a performance value of the communication service related to the VMs/containers is actually calculated, it is not possible to obtain a correct performance value without using a parameter that reflects the dependency of the service performance value on the measurement data. Thus, as a parameter that can be used for estimating the performance value, only measurement data having a correlation with the performance value higher than the second threshold value from the measurement data remaining after the elimination described above may be used. Thus, the correct performance value of the communication service related to the VMs/containers can be obtained.

The invention according to fourth aspect is the network performance assurance system according to third aspect, in which the calculation unit performs first processing in which a change of the number of resources of the VMs/containers is performed between a predetermined minimum number and maximum number, combination candidates of round-robin quantity according to the change are generated, the combination candidates are arranged in order ofascending or descending based on a total amount of each of the combination candidates, the total amount being obtained by summing numbers in each of the combination candidates, retrieval of a condition where the estimation value satisfies the target value of the performance value and the total amount is a minimum value is performed from combination candidates in which the estimation value is associated with the total amount in the order, and termination of the retrieval is performed, after a minimum value of the total amount is retrieved, when the total amount retrieved reaches a value other than the minimum value.

According to this configuration, after all conditions where the estimation value satisfies the target value of the performance value and the total amount has the minimum value are retrieved, the retrieval is terminated when the total amount has a value other than the minimum value. Thus, the retrieval processing can be significantly reduced compared to processing of retrieving all combination candidates of round-robin quantity.

The invention according to fifth aspect is the network performance assurance system according to fourth aspect, in which the calculation unit performs second processing in which a combination candidate of the combination candidates having a minimum absolute value of a difference between a resource allocation amount of running resources of the VMs/containers and a resource allocation amount in which the estimation value satisfying the performance value and the total amount is minimum among the combination candidates retrieved at the termination is selected, and the control unit is notified of a resource allocation amount of the combination candidate that is selected.

According to the configuration, the following effects are obtained. Because the change of the resource allocation amount for the resources of the VMs/containers results in a negative effect, when the resource allocation amount is changed frequently in the communication service, the performance value of the communication service deteriorates. However, in the present invention, a resource allocation amount closest to the resource allocation amount of the currently running resource is selected from among the combination candidates of round-robin quantity for the resources of the VMs/containers. Thus, even if the resource allocation amount is changed on the way, a deterioration in the performance value can be prevented or curbed.

The invention according to sixth aspect is the network performance assurance system according to fifth aspect, in which the calculation unit performs the first processing and the second processing when the performance value becomes greater than a predetermined value or at regular time intervals.

According to this configuration, when the number of users suddenly increases and the performance values (latency, throughput, and the like) of the communication service increase, it is possible to respond to the situation by performing the first processing according to fourth aspect and the second processing according to fifth aspect.

### Effects of the Invention

According to the present invention, it is possible to provide a network performance assurance system and a network performance assurance method that can appropriately control a resource allocation amount such as the number of VMs/containers using autoscaling.

### BRIEF DESCRIPTION OF DRAWINGS

FIG. 1 is a block diagram illustrating a configuration of a network performance assurance system according to an embodiment of the present invention.

FIG. 2 is a block diagram illustrating processing of a learning unit of a controller of an autoscale-type performance assurance system to obtain a model service performance value as a learning result.

FIG. 3 is a block diagram illustrating processing of an optimal estimation calculation unit of the controller to obtain a service performance estimation value of each VM/container for each combination candidate of the number of VMs/containers.

FIG. 4 is a table including total amounts, which are the sum of the number of VMs/containers for each combination candidate of the number of VMs/containers of each of the VMs/containers.

FIG. 5 is a diagram in which the SLO for each combination candidate of the number of VMs/containers for each of the VMs/containers satisfying the condition that is equal to or less than 50 ms and the total amount is the minimum are marked with a circle.

FIG. 6 is a table showing a current combination candidate of VMs/containers.

FIG. 7 is a table including Euclidean distances of the VMs/containers in the combination candidates of the number of VMs/containers satisfying the above-described condition.

FIG. 8 is a sequence diagram for describing an operation of the network performance assurance system according to the present embodiment.

FIG. 9 is a diagram illustrating a plurality of VMs/containers in a VNF.

FIG. 10 is a diagram illustrating an aspect in which the number of particular VMs/containers among a plurality of VMs/containers in a VNF is increased using autoscaling.

### DESCRIPTION OF EMBODIMENTS

Hereinafter, an embodiment of the present invention will be described with reference to the drawings.

### Configuration of Embodiment

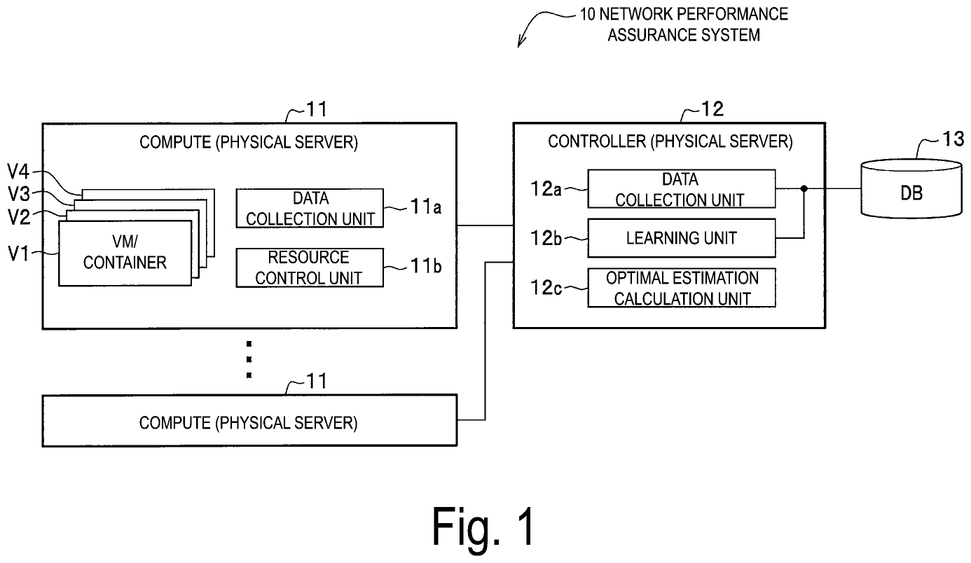

FIG. 1 is a block diagram illustrating a configuration of a network performance assurance system according to an embodiment of the present invention. The network performance assurance system (system) 10 illustrated in FIG. 1 is configured by a controller 12 network-connected to a plurality of computes 11, . . . , and 11 (which will be described below) network-connected to each other.

Each compute 11 includes a data collection unit 11a, a resource control unit 11b, and a plurality of types of VMs/containers V1 to V4.

The controller 12 includes a data collection unit 12a, a learning unit 12b, and an optimal estimation calculation unit 12c. The data collection unit 12a and the learning unit 12b are connected to a database (DB) 13.

Each of the computes 11 and the controller 12 are configured by a physical server (server). However, a server on which VMs/containers V1 to V4 that are virtually created inside operate is defined as a compute 11. The controller 12 is designed to issue an instruction to increase or reduce the number of VMs/containers, and the computes 11 are designed to add or delete the VMs/containers V1 to V4 therein through autoscaling in compliance with the instruction. Note that the VMs/containers V1 to V4 will also be referred to as V1 to V4.

Note that the computes 11 constitute a first server described in the aspects. The controller 12 constitutes a second server described in the aspects. The data collection units 11a and 12a constitute a collection unit described in the aspects. The resource control unit 11b constitutes a control unit described in the aspects. The learning unit 12b constitutes a learning unit described in the aspects. The optimal estimation calculation unit 12c constitutes a calculation unit 12c described in the aspects.

In the system 10, the amount of allocations (resource allocation amounts) to the resources such as CPUs and memories of the computes 11 and the resources of VMs/containers V1 to V4 generated in the computes 11 are changed according to the control of the controller 12. For example, when service performance (or a service performance value) for providing a quality of a communication service such as latency or throughput on a network is deteriorated, a resource allocation amount is changed to add resources. Note that service performance will also be referred to as performance, and a service performance value will also be referred to as a performance value.

In the present invention, when a resource allocation amount is changed at regular intervals or changed using a service performance value as a trigger, a combination of resource allocations of the VMs/containers V1 to V4 that minimizes the resource allocation amounts is optimally retrieved using estimation calculation (optimal estimation retrieval). The resources are allocated using the resource allocation amount obtained in the optimal estimation retrieval, and this allocation achieves the system 10 capable of assuring communication service performance.

In this system 10, three-phase processing including a data collection phase, a learning phase, and an operation phase which are features of the present invention is performed. First, an overview of the three-phase processing will be described.

In the data collection phase, processing to collect service performance values of communication in a network using each of the VMs/containers V1 to V4, usage amounts of resources of the computes 11 and usage amounts of resources of the VMs/containers V1 to V4 (resource usage amount) and a resource allocation amount of each of VMs/containers V1 to V4 is performed.

However, resource usage amounts of the computes 11 include a CPU usage amount, a memory usage amount, and the number of packets transmitted and received of the physical servers constituting the computes 11, and a storage IO (input and output) serving as an auxiliary storage device. A resource usage amount of each of the VMs/containers V1 to V4 includes a vCPU usage amount, a memory usage amount, the number of packets transmitted and received, the number of storage IOs, the number of VMs/containers, and the like of each of the VMs/containers V1 to V4.

In the learning phase, processing to learn a relationship between a service performance value and a resource allocation amount using regression analysis is performed.

In the operation phase, a service performance estimation value (also referred to as a performance estimation value) closest to the SLO (service level objective value or performance target value) is obtained by estimating a service performance value from the result of learning when a resource allocation amount is changed. This performance estimation value is a value for estimating a service performance value. Furthermore, in the operation phase, processing of retrieving a combination of resource allocations that minimizes the resource allocation amount for the VMs/containers V1 to V4 according to the performance estimation value (optimal estimation retrieval) and performing autoscaling according to the retrieved resource allocation amount to change the resource allocation is performed.

Next, details of the three-phase processing will be described. In the system 10, in order to optimally change the resource allocation amount to enhance communication service performance, the controller 12 first instructs the computes 11 to collect data at the time of the generation of the VMs/containers V1 to V4 configuring the service or at regular time intervals. In response to this instruction, while changing the resource allocation amount for each of the VMs/containers V1 to V4, the data collection unit 11a of each compute 11 collects measurement data for the time of the operation of the resources according to the changed amount of resources allocated. This collected measurement data is notified to the data collection unit 12a of the controller 12 and stored in a DB 13.

The learning unit 12b performs the processing of the learning phase based on the measurement data stored in the DB 13 as follows.

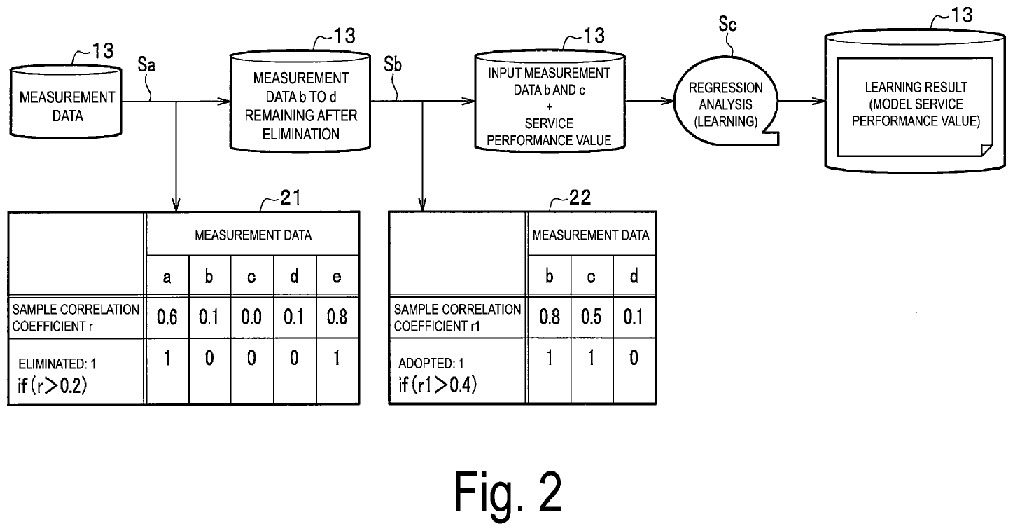

The learning unit 12b eliminates measurement data dependent on the resource allocation amount for each of the VMs/containers V1 to V4 from the measurement data stored in the DB 13 in step Sa illustrated in FIG. 2 as follows. However, the measurement data in the DB 13 includes a resource usage amount (e.g., the number of VMs/containers) according to the resource allocation amount for V1 to V4. At this time, the measurement data is data in accordance with the change because the measurement data is collected while the resource allocation amount is changed as described above. For example, it is assumed that there are the measurement data a, b, c, d, and e as shown in Table 21 of FIG. 2.

Assuming that a resource allocation amount is represented by y and measurement data is represented by x, the learning unit 12b uses a sample covariance Sxy representing a relationship between the two pieces of data y and x, and sample standard deviations Sx and Sy representing the magnitude of the variation in the two pieces of data to calculate a sample correlation coefficient r representing a correlation between the two pieces of data using the following equation (2). Note that the sample covariance will also be referred to as a covariance, the sample standard deviation as a standard deviation, and the sample correlation coefficient as a correlation coefficient.

r=Sxy/SxSy (2)

The correlation coefficient r calculated using the equation (2) is assumed to be “0.6” for the measurement data a, “0.1” for the measurement data b, “0.0” for the measurement data c, “0.1” for the measurement data d, and “0.8” for the measurement data e as shown in Table 21 in FIG. 2.

The learning unit 12b then eliminates measurement data dependent on the resource allocation amount for each of the VMs/containers V1 to V4 from the measurement data a to e. In this elimination, the measurement data a having “0.6” and the measurement data e having “0.8” as correlation coefficients r exceeding a predetermined first threshold value (e.g., 0.2) are eliminated. In other words, the measurement data a and e having a predetermined correlation or greater to the resource allocation amount are eliminated. As shown in Table 21, “1” is appended to the measurement data to be eliminated, and “0” is appended to the measurement data that is not to be eliminated.

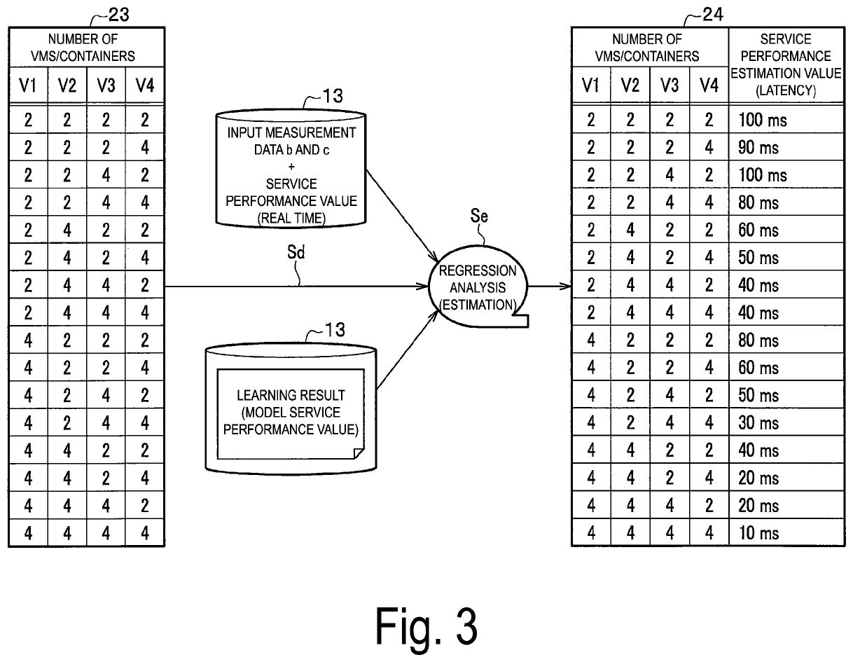

Here, the reason for the elimination of the measurement data (the measurement data a and e above) will be described. A service performance estimation value estimated to acquire an appropriate service performance value is obtained by applying resource allocation amounts (the number of VMs/containers) as combination candidates of the number of VMs/containers (“2, 2, 2, 2” to “4, 4, 4, 4”) of V1 to V4 as shown in Table 23 of FIG. 3 to the following function equation (3).

Performance estimation value=f (resource usage amount, resource allocation amount) (3)

In this case, if the number of VMs/containers of V1 to V4 is as large as the combination “4, 4, 4, 4” as shown in Table 23, latency that is a service performance estimation value (performance) will be as good as 10 ms. On the other hand, if the number of VMs/containers is as small as the combination “2, 2, 2, 2,” latency tends to deteriorate to 100 ms.

However, the above function equation (3) also requires the resource usage amount in addition to the resource allocation amount as an element that contributes to the determination of the performance estimation value. As a result, when the resource allocation amount (the number of VMs/containers) is changed, the resource usage amount (the number of VMs/containers) changes due to this change. In this case, it is not possible to determine which of the resource usage amount and the resource allocation amount affects the change of the performance estimation value.

Thus, it is desired to eliminate the resource usage amount from the function equation (3) in advance. The resource usage amount has a characteristic that the resource usage amount increases when a correlation between the resource allocation amount for V1 to V4 and the measurement data of the resources dependent on the allocation amount is large.

Thus, if the correlation coefficients r between the resource allocation amount y for V1 to V4 and each piece of measurement data x (see Table 21 of FIG. 2) being “0.6” for the measurement data a and “0.8” for the measurement data e exceeding the first threshold value “0.2” are eliminated as described above, the resource usage amount is eliminated from the above function equation (3). In this case, because only the resource allocation amount is used in the function equation (3), an appropriate service performance estimation value dependent only on the resource allocation amount can be obtained.

In this manner, the measurement data b, c, and d remaining after the elimination in step Sa of FIG. 2 are stored in the DB 13.

Next, in step Sb of FIG. 2, the learning unit 12b calculates a sample correlation coefficient r1, which will be described below, for each piece of the remaining measurement data b, c, and d as shown in Table 22, and defines the measurement data b and c in which the correlation is found as input measurement data for regression analysis for service performance.

In other words, the learning unit 12b obtains the correlation coefficient r1 between the service performance value stored in the DB 13 in the data collection phase and each piece of the measurement data b to d. It is assumed that the correlation coefficient r1 is “0.8” for the measurement data b, “0.5” for the measurement data c, and “0.1” for the measurement data d as shown in Table 22.

The learning unit 12b uses the correlation coefficients r1 being “0.8” for the measurement data b and “0.5” for the measurement data c exceeding a predetermined second threshold value “0.4” for regression analysis for the service performance value described below. “1” is appended to the measurement data to be adopted, and “0” is appended to the measurement data that is not to be adopted. The measurement data b and c to be adopted with a high correlation coefficient r1 are stored as input measurement data b and c in the DB 13, along with service performance values.

Here, the reason for obtaining the correlation coefficients r1 between the service performance values and the measurement data b to d described above will be described. When a service performance value is actually calculated, it is not possible to obtain a correct service performance value without using a parameter that reflects the dependency with the measurement data. For this reason, the correlation coefficients r1 need to be calculated for the purpose of extracting only the measurement data b and c from the measurement data b to d as parameters that can be used to estimate the service performance values.

Next, the learning unit 12b performs regression analysis to estimate service performance values (model service performance values) as a model using the input measurement data b and c in step Sc in FIG. 2, and stores the resultant model service performance values as a result of the learning in the DB 13. However, support vector regression (SVR) or the like is used for regression analysis. Note that the model service performance value constitutes the model performance value described in the aspects.

If the model service performance values related to the measurement data (input measurement data) b and c having high correlation coefficients r1 as a result of the learning and the resource allocation amount are used, correct service performance estimation values are obtained in the next operation phase.

In the operation phase, in a case of scale-out/in or scale-up/down performed in autoscaling, the optimal estimation calculation unit 12c generates combination candidates for the resource allocation amount (the number of VMs/containers) as will be described below.

In the case of scale-out/in, the optimal estimation calculation unit 12c sets the number of VMs/containers serving as resource allocation amounts for V1 to V4 shown in Table 23 to, for example, “2” for a minimum number and “4” for a maximum number, and generates combination candidates of round-robin quantity of the number of VMs/containers (resource allocation amount) (“2, 2, 2, 2” to “4, 4, 4, 4”) while sequentially changing the number of VMs/containers by the number of steps, for example, “2” in step Sd of FIG. 3.

In the case of scale-up/down, the optimal estimation calculation unit 12c sets the number of resource allocation sets, which are not illustrated (see the number of VMs/containers of Table 23), serving as resource allocation amounts for V1 to V4 to, for example, “2” for the minimum and “4” for the maximum, and generates combination candidates of round-robin quantity of the number of resource allocation sets (resource allocation amount) (“2, 2, 2, 2” to “4, 4, 4, 4”) while sequentially changing the number of resource allocation sets by the number of steps, for example, “2”. The generation of these combination candidates will be described with a typical case of scale-out/in.

Next, in step Se of FIG. 3, the optimal estimation calculation unit 12c acquires real-time service performance values (referred to as RT service performance values) of the resources at the present time in accordance with the input measurement data b and c in the DB 13, for each of the combination candidates generated for each number of VMs/containers.

Next, the optimal estimation calculation unit 12c performs regression analysis on the relationship between the RT service performance values acquired sequentially for each of the above-described combination candidates and the model service performance value as a learning result stored in the DB 13. Due to the regression analysis, the service performance according to changes in the resource allocation amount (the number of VMs/containers) for each combination candidates for V1 to V4 is estimated. Due to this estimation, the service performance estimation values (targets) for the combination candidates shown in Table 24 are obtained.

By the way, although a large number of combinations are made even when there are two types of combination candidates with the numbers of VMs/containers “2” and “4” in the example, it is only required to narrow down the targets in an optimal estimation retrieval with as few trials as possible. Thus, the following processing is performed.

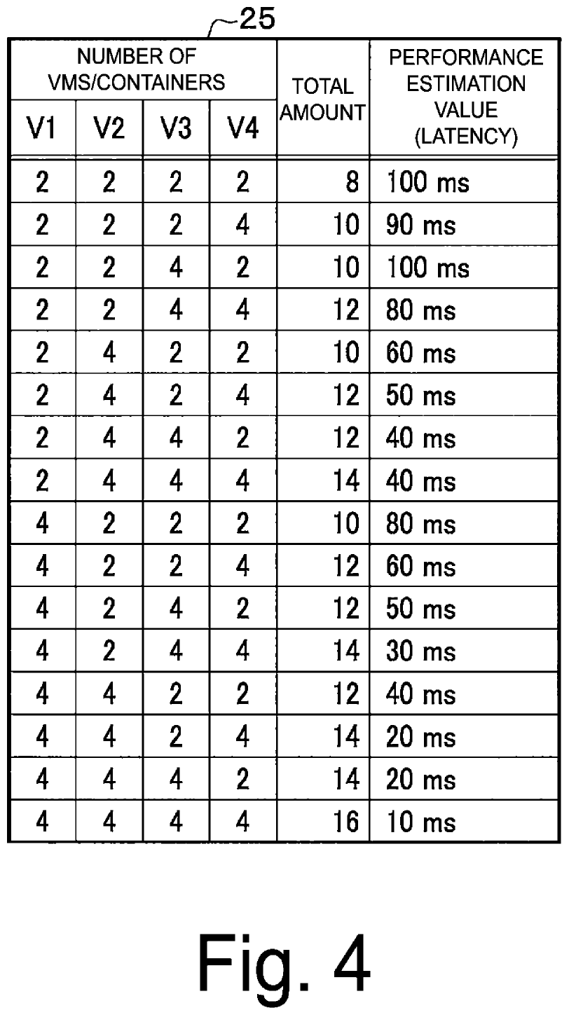

The optimal estimation calculation unit 12c obtains the sums of the numbers of VMs/containers of V1 to V4 for each combination candidate as total amounts as shown in Table 25 in FIG. 4. For example, the sum of the number of VMs/containers in a case in which a combination candidate 0 is “2, 2, 2, 2” is “8,” and thus the total amount is “8”. As the total amount reduces, the number of VMs/containers serving as resources becomes smaller, and therefore, wasted resources are reduced.

Next, the optimal estimation calculation unit 12c retrieves a combination candidate satisfying that the service performance estimation value is equal to or less than the SLO (performance target value) (in other words, satisfying the performance target value), and the total amount is the minimum number of VMs/containers (resource allocation amount). This retrieved combination candidate becomes the optimal resource allocation amount.

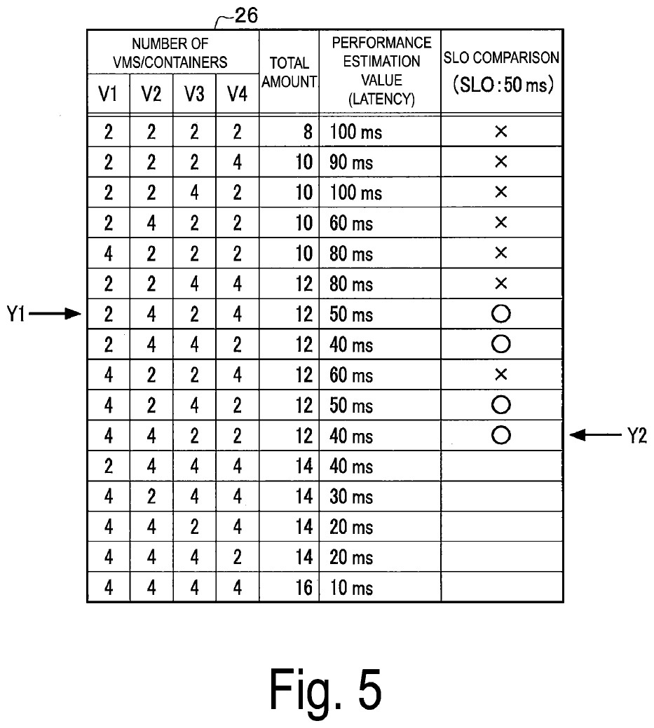

For example, it is assumed that the SLO is 50 ms, as shown in Table 26 of FIG. 5. In this case, a combination candidate having latency that is a performance estimation value being 50 ms or less and the minimum total amount is retrieved. The total amounts are arranged in ascending order from the top of Table 26. Conversely, the total amounts may be arranged in descending order.

The optimal estimation calculation unit 12c retrieves latency that is a performance estimation value (latency) shown in Table 26 of 50 ms or less. In this example, the latency of 50 ms is first retrieved for the combination candidate of the number of VMs/containers “2, 4, 2, 4” indicated by the arrow Y1. At this point, because the first retrieved latency of 50 ms is involved with the minimum total amount “12,” the combination candidate with latency of 50 ms or less and the minimum total amount “12” is determined. The field of SLO comparison for this determined combination candidate is marked with a circle.

Furthermore, after the determination, the fields of SLO comparison are sequentially marked with a circle each time combination candidates with a determined latency of 50 ms or less and the minimum total amount “12” are sequentially retrieved while retrieving the minimum total amount “12”. During this retrieval, the retrieval operation terminates at the time the total amount indicated by arrow Y2 becomes “14” next to “12,” i.e., the total amount exceeds the minimum value in the example of Table 26. In this retrieval, it is assumed that there are four combination candidates of the number of VMs/containers (resource allocation amount) with latency of 50 ms or less and the minimum total amount “12” as marked with a circle.

Here, as for the number of VMs/containers of V1 to V4, if there are as few changes as possible, the resources fluctuate will be less and the performance target value will be less affected, and thus it is desireable to avoid change in the number of VMs/containers as much as possible. In a case in which the number of VMs/containers of V1 to V4 is set to “2, 2, 2, 4” shown in Table 27 of FIG. 6, for example, it is necessary to avoid a change such as reducing “4” of V4 and increasing “2” of V1, for example. Therefore, there is a need to retrieve a combination candidate with as few changes as possible in the number of VMs/containers. This retrieval is performed using the Euclidean distance as follows.

The optimal estimation calculation unit 12c calculates a combination candidate with a minimum Euclidean distance between the resource allocation amount (the number of VMs/containers) of the current VMs/containers V1 to V4 and the resource allocation amount (the number of VMs/containers) having the performance estimation value obtained above being less than or equal to the SLO and having the minimum total amount.

Here, a combination candidate with a minimum Euclidean distance d between the resource allocation amounts (r_{V1}, r_{V2}, . . . , and r_{Vn}) of the current VMs/containers V1, . . . , and Vn), respectively, and the combination candidates (r′_{V1}, r′_{V2}, . . . , and r′_{Vn}) is obtained by determining the Euclidean distance d in the following equation (4).

d=√{(r_{V1}−r′_{V1})²+(r_{V2}−r′_{V2})²+ . . . +(r_{Vn}−r′_{Vn})²} (4)

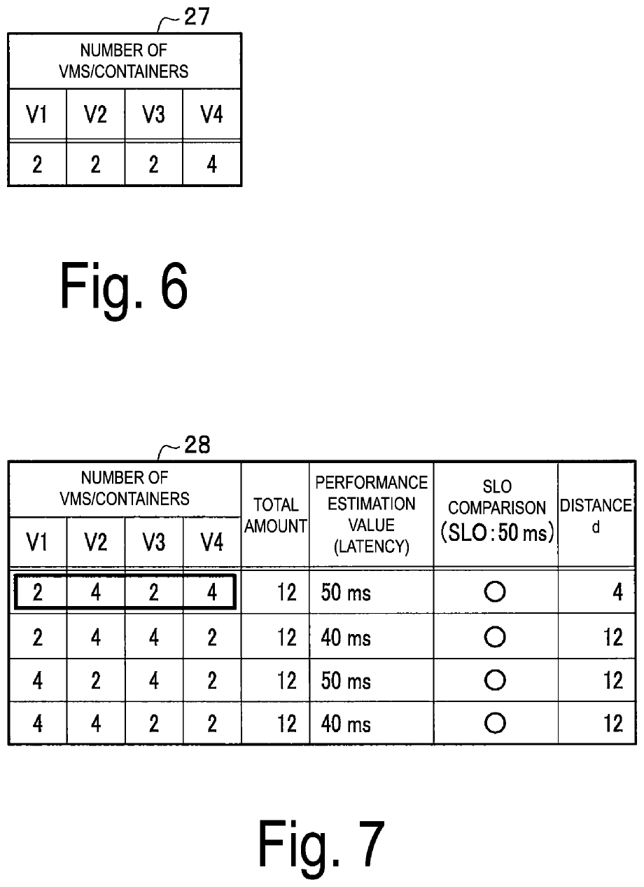

Using this equation (4), the Euclidean distance d is obtained, as follows. That is, the Euclidean distance d between the current combination of V1 to V4 “2, 2, 2, 4” shown in Table 27 in FIG. 6 and the combination candidate “2, 4, 2, 4” shown in the first row of Table 28 in FIG. 7 is the result “4” obtained by calculating the square root which is the calculation result of (2−2)²+(2−4)²+(2−2)²+(4−4)². The result “4” is written into the field of distance d. Then, similarly, the calculation result of each of the second to fourth rows is “12”.

As a result, the optimal estimation calculation unit 12c adopts, as the resource allocation amount for the VMs/containers V1 to V4, the number of VMs/containers “2, 4, 2, 4” of the combination candidate in the first row shown in Table 28 in which the Euclidean distance d is smallest.

The adopted resource allocation amount of V1 to V4 (the number of VMs/containers) “2, 4, 2, 4” is notified to the resource control unit 11b of the compute 11. The resource control unit 11b performs control to set the number of VMs/containers which are resources of the VMs/containers V1 to V4 as a resource allocation amount “2, 4, 2, 4”. Due to this control, optimal communication service performance of the system 10 can be assured.

### Operations of Embodiment

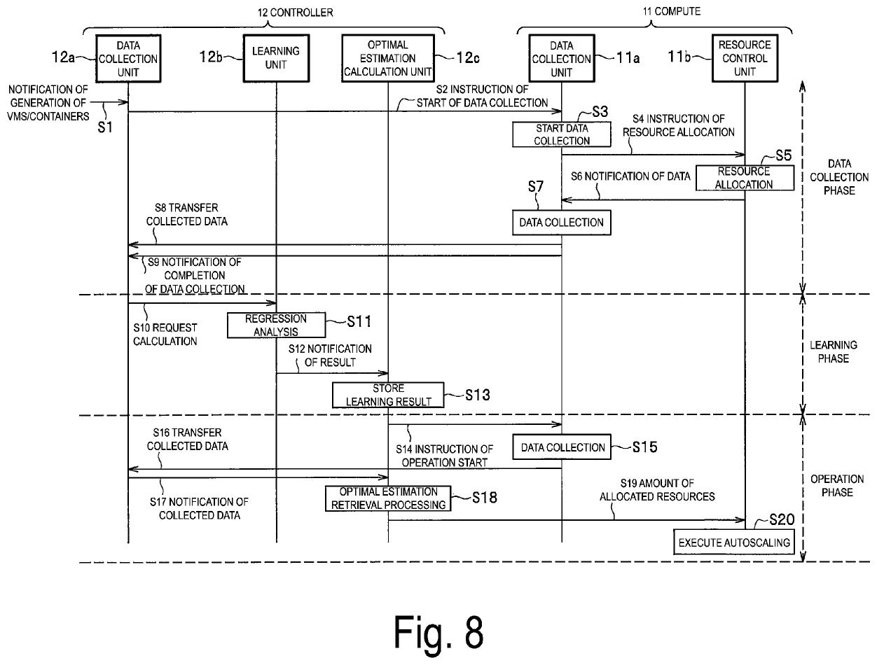

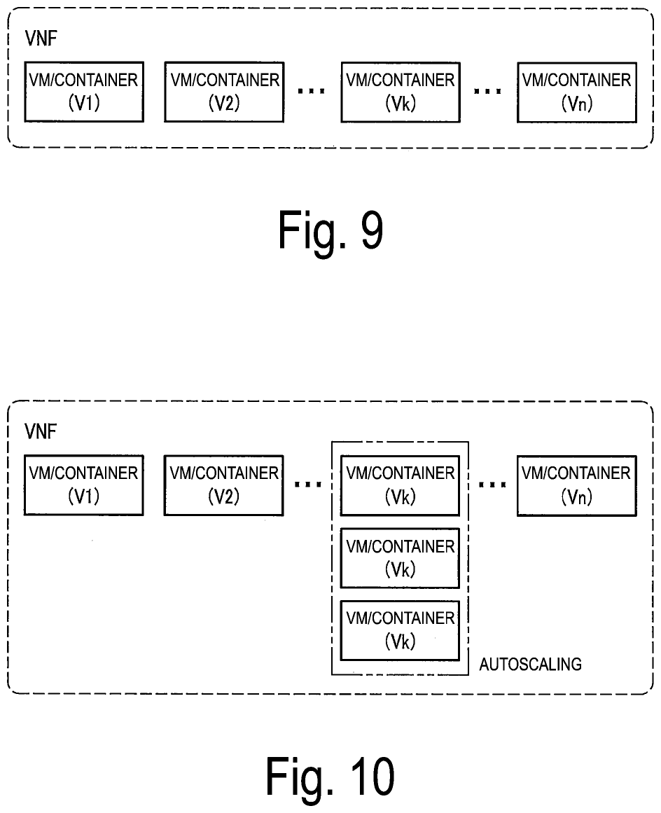

Next, an operation of the network performance assurance system according to the present embodiment will be described with reference to the sequence diagram of FIG. 8.

It is assumed in step S1 that the compute 11 notifies the data collection unit 12a of the controller 12 of the generation of VMs/containers V1 to V4 (FIG. 1). After receiving this notification, the data collection unit 12a gives a data collection start instruction to the compute 11 in step S2.

After receiving this notification, the data collection unit 11a of the compute 11 starts collecting data of the number of VMs/containers V1 to V4 generated above, and performance values of the resources such as latency and throughput in step S3.

In step S4, the data collection unit 11a gives an instruction (resource allocation instruction) for increase or reduction of the resources of the VMs/containers V1 to V4 by adding or deleting the resources to the resource control unit 11b. In step S5, the resource control unit 11b controls resource allocation for increasing or decreasing the resources of V1 to V4 in compliance with the instruction. In this control, it is assumed that the number of VMs/containers as resources of V1 to V4 is determined, and measurement data of the latency, which is a service performance value at this time, is also obtained. For example, measurement data a to e shown in Table 21 of FIG. 2 are obtained. In addition, measurement data of the resources such as an amount of CPU usage of the entire physical server, an amount of CPU usage and a resource allocation amount of the individual VMs/containers, and the like are obtained.

In step S6 of FIG. 8, the resource control unit 11b notifies the data collection unit 11a of the number of VMs/containers determined in the resource allocation above and the measurement data of the service performance value.

The data collection unit 11a collects the notified measurement data in step S7 and transfers the collected data to the data collection unit 12a of the controller 12 in step S8. This transferred collected data is stored in the DB 13 (FIG. 1).

The processing operations of steps S4 to S8 described above are repeated as follows. For example, the number of VMs/containers serving as resource allocation amounts for V1 to V4 shown in Table 23 of FIG. 3 is set to “2” for the minimum and “4” for the maximum, and combination candidates of round-robin quantity of the number of VMs/containers (“2, 2, 2, 2” to “4, 4, 4, 4”) are generated while the number of VMs/containers are sequentially changed by the number of steps “2”. In the repetitive generation, measurement data of the resources is collected, notified to the data collection unit 12a, and stored in the DB 13.

When a predetermined number of pieces of data in various patterns is collected through the repeated processing operations of steps S4 to S8 above, the data collection unit 11a of the compute 11 notifies the data collection unit 12a of the controller 12 of the completion of the data collection (step S9). The data collection phase ends when the data collection unit 12a receives this notification.

After receiving the completion of the data collection above, the data collection unit 12a requests the learning unit 12b for calculation in the learning phase in step S10.

After receiving the request, the learning unit 12b performs regression analysis in step S11 as follows based on the collected data stored in the DB 13.

In other words, the learning unit 12b first obtains correlation coefficients r between the measurement data a to e shown in Table 21 of FIG. 2 stored in the DB 13 and the resource allocation amount used in the resource allocation in step S5 above. Next, the measurement data a and e having a correlation coefficient r exceeding the first threshold value “0.2” are eliminated. The correlation coefficient r1 between the measurement data b, c, and d remaining after the elimination shown in Table 22 of FIG. 2 and the service performance value stored in the DB 13 in the data collection phase is obtained. Regression analysis is performed using the measurement data b and c having the correlation coefficient r1 exceeding the second threshold value “0.4”. A model service performance value as a result of the learning is obtained due to the regression analysis.

Next, in step S12 shown in FIG. 8, the learning unit 12b notifies the optimal estimation calculation unit 12c of the model service performance value as the learning result obtained in the regression analysis. The optimal estimation calculation unit 12c stores the model service performance value of the learning result in the DB 13 in step S13. The learning phase ends with this storage.

After storing the model service performance value, the optimal estimation calculation unit 12c notifies the compute 11 of an operation start instruction in step S14. The data collection unit 11a of the compute 11 that receives this notification collects the measurement data at the time of the operation of the resources from the VMs/containers V1 to V4 in step S15 and transfers the collected data to the data collection unit 12a of the controller 12 in step S16. The data collection unit 12a notifies the optimal estimation calculation unit 12c of the transferred collected data in step S17.

In step S18, the optimal estimation calculation unit 12c performs optimal estimation retrieval processing as follows. However, it is assumed that resource allocation is performed by using scale-out/in in an operation phase. First, the optimal estimation calculation unit 12c generates combination candidates of round-robin quantity of the number of VMs/containers (“2, 2, 2, 2” to “4, 4, 4, 4”) as resource allocation amounts for V1 to V4 shown in Table 23 in FIG. 3.

Next, the optimal estimation calculation unit 12c performs regression analysis for each of the combination candidates above based on the relationship between the RT service performance value which is a real-time service performance value of the resources in accordance with the input measurement data b and c in the DB 13 and the model service performance value as the learning result stored in the DB 13 in step S13. Due to regression analysis, service performance estimation values (latency) for each of the combination candidates shown in Table 24 of FIG. 3 are obtained.

Next, the optimal estimation calculation unit 12c obtains the sum of each of the combination candidates shown in Table 25 in FIG. 4 as total amount. As the total amounts reduce, wasted resources are reduced more. Next, the optimal estimation calculation unit 12c retrieves a combination candidate satisfying that the performance estimation value shown in Table 26 of FIG. 5 is less than or equal to the SLO (50 ms) and the total amount is the minimum number of VMs/containers. It is assumed that there are four combination candidates marked with a circle in the field of SLO comparison as a result of the retrieval.

Here, when the number of VMs/containers of V1 to V4 is operated with the combination “2, 2, 2, 4” shown in Table 27 of FIG. 6, the Euclidean distance d between the combination “2, 2, 2, 4” and the combination candidate “2, 4, 2, 4” in each row in Table 27 of FIG. 7 is calculated. The combination candidate “2, 4, 2, 4” in the first row in which the Euclidean distance d is the smallest value “4” is adopted as the number of VMs/containers, which is the resource allocation amount for the VMs/containers V1 to V4.

The optimal estimation calculation unit 12c notifies the resource control unit 11b of the compute 11 of the adopted resource allocation amount for V1 to V4 (the number of VMs/containers) “2, 4, 2, 4” in step S19. In step S20, the resource control unit 11b executes autoscaling by performing scale-out/in to control the number of VMs/containers, which are resources for the VMs/containers V1 to V4, to be “2, 4, 2, 4” of the resource allocation amount. Due to this control, optimal communication service performance of the system 10 is assured.

### Effects of Embodiment

Next, effects of the network performance assurance system 10 according to the present embodiment will be described. The system 10 performs autoscaling to increase or reduce the number of VMs/containers V1 to V4, which are either or both of VMs and containers generated in a network-connected server and resources typified by a CPU and a memory of the VMs/containers V1 to V4 according to a resource allocation amount. Feature configurations of the system 10 will be described.

(1) The system 10 is configured to include, in the compute 11, a plurality of types of VMs/containers V1 to V4, the data collection unit 11a, and the resource control unit 11b, and in the controller 12, the learning unit 12b and the optimal estimation calculation unit 12c.

The data collection unit 11a collects measurement data including a resource usage amount obtained by measuring an operation of resources according to a resource allocation amount of the VMs/containers V1 to V4 and performance values of a communication service related to the VMs/containers V1 to V4. The resource control unit 11b performs autoscaling to increase or reduce the resources of the VMs/containers V1 to V4 according to the resource allocation amount.

The learning unit 12b obtains, from the performance values included in the measurement data collected by the data collection unit 11a, a performance value having a high correlation with the resource allocation amount as a model performance value. The optimal estimation calculation unit 12c obtains a performance estimation value in accordance with a change in the resource allocation amount using regression analysis on the model performance value and the performance value related to an operation of the resources corresponding to the model performance value, and calculates the resource allocation amount when the estimation value satisfies the target value of the performance value and the resource allocation amount is minimized. Furthermore, the resource control unit 11b increases or reduces the resources of the VM/containers V1 to V4 by executing autoscaling in accordance with the calculated resource allocation amount.

According to this configuration, the execution of the autoscaling in a small amount of allocated resources enables resource allocation to be performed so that there are less wasted resources in the VMs/containers V1 to V4. As a result, the resource allocation amount such as the number of VMs/containers V1 to V4 can be appropriately controlled due to the autoscaling.

(2) The learning unit 12b has a configuration in which measurement data having the correlation between the measurement data and the resource allocation amount of the VM/containers V1 to V4 is greater than the predetermined first threshold value is eliminated from the measurement data collected by the data collection unit 11a.

According to this configuration, the following effects are obtained. When resources of the VMs/containers V1 to V4 are changed according to the resource allocation amount, the measurement data changed due to the aforementioned change (corresponding to the resource usage amount) is inappropriate for obtaining the model performance value. This inappropriate measurement data tends to increase when there is a high correlation with the measurement data of resources dependent on the resource allocation amount. Therefore, if the inappropriate measurement data is eliminated in advance as in the present invention, accuracy with which the model performance value can be estimated can be increased.

(3) The learning unit 12b has a configuration in which, from measurement data remaining after the elimination, measurement data having a correlation with the performance value of the communication service related to the VMs/containers V1 to V4 being greater than the predetermined second threshold value is used to obtain the model performance value.

According to this configuration, when a performance value of the communication service related to the VMs/containers V1 to V4 is actually calculated, it is not possible to obtain a correct performance value without using a parameter that reflects the dependency with the measurement data. Thus, as a parameter that can be used for estimating the performance value, only measurement data having a correlation with the performance value higher than the second threshold value from the measurement data remaining after the elimination described above may be used.

(4) The optimal estimation calculation unit 12c is configured to perform first processing described below. In the first processing, the optimal estimation calculation unit 12c changes the number of resources of the VMs/containers V1 to V4 from a predetermined minimum number to maximum number. Furthermore, in the first processing, the optimal estimation calculation unit 12c generates combination candidates of round-robin quantity according to the change. Furthermore, in the first processing, the optimal estimation calculation unit 12c arranges combination candidates that are generated in order of ascending or descending based on a total amount, which is obtained by summing numbers in each of the combination candidates, of each of the combination candidates, and retrieves a condition where the estimation value satisfies the target value of the performance value and the total amount is a minimum value from combination candidates in which the estimation value is associated with the total amount in the order. Furthermore, in the first processing, after the minimum value of the total amount is retrieved, the optimal estimation calculation unit 12c terminates the retrieval when the total amount retrieved reaches a value other than the minimum value.

According to this configuration, after all conditions that the estimation value satisfies the target value of the performance value and the total amount is the minimum value are retrieved, the retrieval is terminated when the total amount has a value other than the minimum value. Thus, the retrieval processing can be significantly reduced compared to processing of retrieving all combination candidates of round-robin quantity.

(5) The optimal estimation calculation unit 12c is configured to perform second processing described below. In the second processing, the optimal estimation calculation unit 12c selects a combination candidate having a minimum absolute value of a difference between a resource allocation amount of running resources of the VMs/containers V1 to V4 and a resource allocation amount in which the estimation value satisfying the performance value and the total amount is minimum among the combination candidates retrieved at the termination. Furthermore, in the second processing, the optimal estimation calculation unit 12c notifies the resource control unit 11b of the resource allocation amount of the selected combination candidate.

According to the configuration, the following effects are obtained. Because the change of the resource allocation amount for the resources of the VMs/containers V1 to V4 results in a negative effect, when the resource allocation amount is changed frequently in the communication service, the performance value of the communication service deteriorates. However, in the present invention, a resource allocation amount closest to the resource allocation amount of the currently running resource is selected from among the combination candidates of round-robin quantity for the resources of the VMs/containers V1 to V4. Thus, even if the resource allocation amount is changed on the way, a deterioration in the performance value can be prevented or curbed.

In addition, the optimal estimation calculation unit 12c may perform the above-described first and second processing operations when the performance value becomes greater than a predetermined value or at regular time intervals.

According to this configuration, when the number of users suddenly increases and the performance values (latency, throughput, and the like) of the communication service increases, it is possible to respond to the situation by performing the first processing and the second processing.

In addition, a specific configuration can be appropriately changed without departing from the gist of the present invention.

### REFERENCE SIGNS LIST

10 Network performance assurance system
11 Compute (first server)
11a Data collection unit
11b Resource control unit
12 Controller (second server)
12a Data collection unit
12b Learning unit
12c Optimal estimation calculation unit
13 DB
V1 to V4 VM/container

1. A network performance assurance system configured to perform autoscaling to increase or reduce a number of VMs/containers, which are either or both of virtual machines (VMs) and containers generated on a network-connected server and resources typified by a central processing unit (CPU) and a memory of each of the VMs/containers according to a resource allocation amount, the network performance assurance system comprising:
a first server including
a plurality of types of the VMs/containers,
a collection unit, including one or more processors, configured to collect measurement data including a resource usage amount obtained by measuring an operation of resources according to a resource allocation amount of the VMs/containers and a performance value of a communication service related to the VMs/containers, and
a control unit, including one or more processors, configured to perform autoscaling to increase or reduce resources of the VMs/containers according to the resource allocation amount; and
a second server including
a learning unit, including one or more processors, configured to obtain, from the performance value included in the measurement data collected by the collection unit, a performance value having a high correlation with the resource allocation amount as a model performance value, and
a calculation unit, including one or more processors, configured to obtain an estimation value of a performance according to a change in the resource allocation amount using regression analysis of the model performance value and a performance value related to the operation of resources corresponding to the model performance value and calculate a resource allocation amount when the estimation value satisfies a target value of the performance value and the resource allocation amount is minimized,
wherein the control unit is configured to increase or reduce resources of the VMs/containers by executing autoscaling according to the resource allocation amount that is calculated.

2. The network performance assurance system according to claim 1,
wherein the learning unit, is configured to eliminate, from the measurement data collected by the collection unit, measurement data having a correlation between the measurement data and the resource allocation amount of the VMs/containers being greater than a predetermined first threshold value.

3. The network performance assurance system according to claim 2,
wherein the learning unit is configured to use, from measurement data remaining after the elimination, measurement data having a correlation with the performance value of the communication service related to the VMs/containers being greater than a predetermined second threshold value to obtain the model performance value.

4. The network performance assurance system according to claim 3,
wherein the calculation unit, is configured to perform first processing in which a change of a number of resources of the VMs/containers is performed between a predetermined minimum number and maximum number, combination candidates of round-robin quantity according to the change are generated, the combination candidates that are generated are arranged in an order of ascending or descending based on a total amount of each of the combination candidates, the total amount being obtained by summing numbers in each of the combination candidates, retrieval of a condition where the estimation value satisfies the target value of the performance value and the total amount is a minimum value is performed from combination candidates in which the estimation value is associated with the total amount in the order, and termination of the retrieval is performed, after a minimum value of the total amount is retrieved, when the total amount retrieved reaches a value other than the minimum value.

5. The network performance assurance system according to claim 4,
wherein the calculation unit, is configured to perform second processing in which a combination candidate of the combination candidates having a minimum absolute value of a difference between a resource allocation amount of running resources of the VMs/containers and a resource allocation amount in which the estimation value satisfying the performance value and the total amount is minimum among the combination candidates retrieved at the termination is selected, and the control unit is notified of a resource allocation amount of the combination candidate that is selected.

6. The network performance assurance system according to claim 5,
wherein the calculation unit, is configured to perform the first processing and the second processing when the performance value becomes greater than a predetermined value or at regular time intervals.

7. A network performance assurance method that is an autoscale-type performance assurance method of a system that performs autoscaling to increase or reduce a number of VMs/containers, which are either or both of VMs and containers generated on a network-connected server and resources typified by a CPU and a memory of each of the VMs/containers according to a resource allocation amount,
wherein the system includes a first server in which a plurality of types of the VMs/containers are generated, and a second server connected to the first server, the method comprising:
by the first server, collecting measurement data including a resource usage amount obtained by measuring an operation of resources according to a resource allocation amount of the VMs/containers and a performance value of a communication service related to the VMs/containers,
by the first server, performing autoscaling to increase or reduce resources of the VMs/containers according to the resource allocation amount,
by the second server, obtaining, from the performance value included in the measurement data collected, a performance value having a high correlation with the resource allocation amount as a model performance value,
by the second server, obtaining an estimation value of a performance according to a change in the resource allocation amount using regression analysis of the model performance value and a performance value related to the operation of resources corresponding to the model performance value and calculating a resource allocation amount when the estimation value satisfies a target value of the performance value and the resource allocation amount is minimized, and
by the first server, increasing or reducing resources of the VMs/containers by executing autoscaling according to the resource allocation amount that is calculated.

8. The network performance assurance method according to claim 7, further comprising:
by the second server, eliminating from the measurement data collected, measurement data having a correlation between the measurement data and the resource allocation amount of the VMs/containers being greater than a predetermined first threshold value.

9. The network performance assurance method according to claim 8, further comprising:
by the second server, using from measurement data remaining after the elimination, measurement data having a correlation with the performance value of the communication service related to the VMs/containers being greater than a predetermined second threshold value to obtain the model performance value.

10. The network performance assurance method according to claim 9, further comprising:
by the second server, performing first processing in which a change of a number of resources of the VMs/containers is performed between a predetermined minimum number and maximum number, combination candidates of round-robin quantity according to the change are generated, the combination candidates that are generated are arranged in an order of ascending or descending based on a total amount of each of the combination candidates, the total amount being obtained by summing numbers in each of the combination candidates, retrieval of a condition where the estimation value satisfies the target value of the performance value and the total amount is a minimum value is performed from combination candidates in which the estimation value is associated with the total amount in the order, and termination of the retrieval is performed, after a minimum value of the total amount is retrieved, when the total amount retrieved reaches a value other than the minimum value.

11. The network performance assurance method according to claim 10, further comprising:
by the second server, performing second processing in which a combination candidate of the combination candidates having a minimum absolute value of a difference between a resource allocation amount of running resources of the VMs/containers and a resource allocation amount in which the estimation value satisfying the performance value and the total amount is minimum among the combination candidates retrieved at the termination is selected, and the first server is notified of a resource allocation amount of the combination candidate that is selected.

12. The network performance assurance method according to claim 11, further comprising:
by the second server, performing the first processing and the second processing when the performance value becomes greater than a predetermined value or at regular time intervals.
